(19) United States
(12) Patent Application Publication
(10) Pub. No.: US 2010/0194771 A1
(43) Pub. Date: Aug. 5, 2010

(54) LIQUID CRYSTAL DISPLAY DEVICE

(75) Inventors: Takeshi HARAYAMA, Mobara (JP); Yuu TAKAHASHI, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/699,117

(22) Filed: Feb. 3, 2010

(30) Foreign Application Priority Data
Feb. 3, 2009 (JP) 2009-022154

(51) Int. Cl. G09G 3/36; G02F 1/1333

(52) U.S. Cl. 345/589; 349/58

(57) ABSTRACT

There is provided a liquid crystal display device that can easily suppress color variation, even if there is a difference in white tolerance of the backlight. The liquid crystal display device includes a liquid crystal display panel to which an image signal is input, and a backlight provided on one side of the liquid crystal display panel, using a light emitting diode as a light source of the backlight. Information about the white tolerance of the light source using the light emitting diode, which indicates one rank of plural ranks assigned to the white tolerance, is clearly indicated in a portion of the backlight. The information is input to an image quality processing circuit in order to correct gamma characteristics of the image signal according to the information.

### CLAIM OF PRIORITY

The present application claims priority from Japanese Patent Application JP 2009-022154 filed on Feb. 3, 2009, the content of which is hereby incorporated by reference into this application.

### FIELD OF THE INVENTION

The present invention relates to a liquid crystal display device. More particularly, the present invention relates to a liquid crystal display device having a liquid crystal display panel and a backlight provided on one side of the liquid crystal display panel, using a light emitting diode as a light source of the backlight.

### BACKGROUND OF THE INVENTION

In general, a liquid crystal display panel is designed to independently control the amount of light transmission of each pixel by providing a backlight on the back side of the liquid crystal display panel.

An example of such a backlight is a backlight including a light guide panel provided to face the liquid crystal display panel, and a light source provided at least on one side of the side wall surface of the light guide panel. In this case, the backlight causes the light source to function as a surface light source. In other words, the light from the light source is incident to the side wall surface, reflected or refracted in the light guide panel, and then output from the surface facing the liquid crystal display panel.

There is also a backlight using a cold cathode fluorescent lamp as the light source. In recent years, a backlight using a light emitting diode as a light source has been widely used, for reducing the power consumption and the like. More specifically, the light source includes a strip-shaped flexible substrate in which plural white light emitting diodes are arranged in the longitudinal direction of the flexible circuit substrate, which is provided so that each of the light emitting diodes faces at least on one side of the side wall of the light guide panel.

A detailed description of the liquid crystal display device having such a backlight can be found, for example, in JP-A No. 89944/2008.

In the case of the backlight using a light emitting diode as the light source, however, it is inevitable that the so-called white tolerance should occur due to color variation in each light emitting diode. For example, the color variation of the backlight using a light emitting diode is about six times the color variation of a backlight using a cold cathode fluorescent lamp.

For this reason, obtaining a liquid crystal display device with less color variation requires a backlight with a small white tolerance. However, from the above circumstances, the production of the backlight with a small white tolerance is difficult, resulting in an increase in costs.

In this case, even if a backlight with a relatively large white tolerance is used in a liquid crystal display device, the problem can be solved by providing an image quality processing circuit that can correct the gamma characteristics of an image signal based on a lockup table for image control. As a result, because of this correction, the color variation in the liquid crystal display device can be suppressed.

In this case, however, the correction should be performed, for example, while detecting the light from the backlight passing through the liquid crystal display panel. As a result, the operation is complicated.

### SUMMARY OF THE INVENTION

The present invention aims to provide a liquid crystal display device that can easily suppress the color variation, even if there is a difference in the white tolerance of the backlight.

In the liquid crystal display device according to the present invention, the rank of the color tolerance of the light source is clearly indicated in the backlight in order correct the gamma characteristics according to the rank. As a result, it is possible to very easily suppress the color variation in the liquid crystal display device.

For example, the present invention may be configured as follows.

(1) A liquid crystal display device, according to the present invention, includes a liquid crystal display panel to which an image signal is input, and a backlight provided on one side of the liquid crystal display panel, using a light emitting diode as a light source of the backlight. Information about white tolerance of the light source using the light emitting diode, indicating one rank of plural ranks assigned to the white tolerance, is clearly indicated in a portion of the backlight. The liquid crystal display device further includes an image quality processing circuit to which the information can be input in order to correct gamma characteristics of the image signal according to the information.

(2) In the liquid crystal display device according to the present invention described in (1), the backlight includes at least a light guide panel provided to face the liquid crystal display panel, and plural light emitting diodes arranged in parallel on the flexible circuit substrate so that the plural light emitting diodes face at least one side of a side wall surface of the light guide panel. The information indicating the rank of the white tolerance of the light source using the light emitting diodes, is clearly indicated in the flexible circuit substrate.

(3) In the liquid crystal display device according to the present invention described in (2), the light guide panel, the light emitting diodes, and the flexible circuit substrate are housed in a frame. The frame includes a control circuit substrate for driving the light emitting diodes through the flexible circuit substrate, which is provided on a surface of the frame opposite to a surface on which the light guide panel, the light emitting diodes, and the flexible circuit substrate are mounted. An end of the flexible circuit substrate is electrically coupled to the control circuit substrate through a connector. The information indicating the rank of the white tolerance of the light source using the light emitting diodes, is clearly indicated in a portion adjacent to the connector of the flexible circuit substrate.

(4) In the liquid crystal display device according to the present invention described in (3), the information indicating the rank of the white tolerance of the light source using the light emitting diodes, is clearly indicated by means of a dummy resistance attached to the flexible circuit substrate.

(5) In the liquid crystal display device according to the present invention described in (3), the information indicating the rank of the white tolerance of the light source using the light emitting diodes, is clearly indicated by means of a bar code printed on the flexible circuit substrate.

(6) In the liquid crystal display device according to the present invention described in (3), the information indicating the rank of the white tolerance of the light source using the light emitting diodes, is displayed at least on one of a front surface and a back surface of the flexible circuit substrate.

(7) A liquid crystal display device, according to the present invention, includes a liquid crystal display panel to which an image signal is input, and a backlight provided on one side of the liquid crystal display panel, using a light emitting diode as a light source of the backlight. Information about white tolerance of the light source using the light emitting diode, indicating one rank of plural ranks assigned to the white tolerance, is stored in a memory device in a portion of the backlight. The liquid crystal display device further includes an image quality processing circuit to which the information stored in the memory device can be input in order to correct gamma characteristics of the image signal according to the information.

(8) In the liquid crystal display device according to the present invention described in (7), the backlight includes at least a light guide panel provided to face a liquid crystal display panel, plural light emitting diodes provided to face a side wall surface of the light guide panel, and a flexible circuit substrate on which the plural light emitting diodes are mounted. The memory device is mounted on the flexible circuit substrate.

(9) In the liquid crystal display device according to the present invention described in (7), the memory device is electrically coupled to the image quality processing circuit, so that the information stored in the memory device can be output to the image quality processing circuit.

(10) In the liquid crystal display device according to the present invention described in (1) or (7), the backlight includes plural light emitting diodes that are dispersed on a surface facing the liquid crystal display panel.

It is to be understood that the above configurations are merely examples of the present invention, and the present invention may be modified appropriately without departing from the technical spirit and scope of the present invention. Examples of the configuration according to the present invention, other than the configurations described above, will become apparent from the description of the present specification and the accompanying drawings.

With the liquid crystal display device configured as described above, it is possible to easily suppress the color variation, even if there is a difference in the white tolerance of the backlight.

Other advantages of the present invention will become apparent from the description of the following specification.

### BRIEF DESCRIPTION OF THE DRAWINGS

FIGS. 1A, 1B, 1C are schematic views showing an essential part of a liquid crystal display device according to embodiments of the present invention, which are enlarged views of a portion A surrounded by the dotted line in FIG. 4;

FIG. 2 is a schematic view of a liquid crystal display device according to an embodiment of the present invention, which is an exploded top view of the liquid crystal display device;

FIG. 3 is a perspective view of a light source used for a backlight of a liquid crystal display device according to an embodiment of the present invention;

FIG. 4 is a top view of a liquid crystal display device according to an embodiment of the present invention, as seen from the side of a frame; and

FIG. 5 is a block diagram of an image control circuit of a liquid crystal display device according an embodiment of the present invention.

### DETAILED DESCRIPTION OF THE PREFERRED EMBODIMENTS

Preferred embodiments of the present invention will be described with reference to the accompanying drawings. The same or similar components are designated by the same reference numerals throughout the respective figures and embodiments, and the description thereof will be omitted.

### First Embodiment

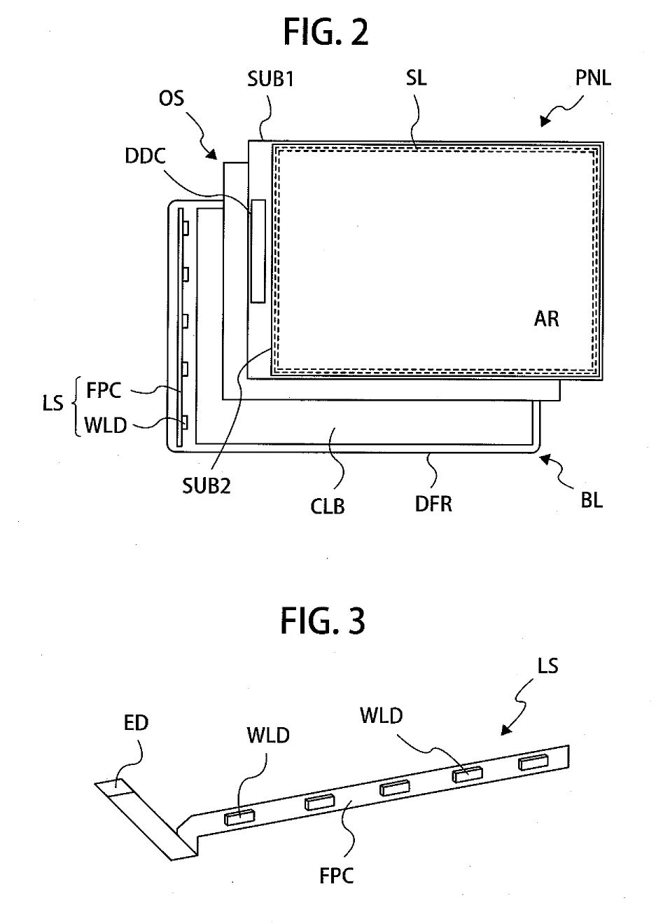

FIG. 2 is a schematic view of a liquid crystal display device according to a first embodiment of the present invention, which is an exploded top view of the liquid crystal display device.

In FIG. 2, the liquid crystal display device includes a liquid crystal display panel PNL, an optical sheet OS, and a backlight BL, in this order from the observer side (the front of the paper).

The liquid crystal display panel PNL has an envelope of substrates SUB1 and SUB2 facing each other with a liquid crystal therebetween. An image display unit AR having plural pixels is provided in the envelope of the liquid crystal display panel PNL. Further, the liquid crystal between the substrates SUB1 and SUB2 is sealed with a sealing material SL formed around the image display unit AR.

Although not shown, the image display unit AR includes a large number of pixels arranged in matrix form. The liquid crystal display panel PNL is designed to provide color display in the following way. For example, three adjacent pixels displaying red (R), green (G), and blue (B) colors form a pixel unit for color display. Then, a predetermined gradation voltage is applied to each pixel of the pixel unit to allow the pixel unit to display a given color.

The substrate SUB1 has a portion exposed from the substrate SUB2 in a periphery thereof. A display driving circuit DDC of a semiconductor chip is mounted on the exposed portion of the substrate SUB1. The display driving circuit DDC displays a given image on the image display unit AR by applying a predetermined voltage independently to each pixel of the pixel unit.

The optical sheet OS is formed, for example, by a prism sheet or a diffusion sheet, and the like, which focuses or diffuses the light from the backlight BL described below to guide the light to the side of the liquid crystal display panel PNL.

The backlight BL includes a light guide panel CLB facing at least the image display unit AR of the liquid crystal display panel PNL, as well as a light source LS using plural white light emitting diodes WLD arranged in the longitudinal direction of a strip-shaped flexible circuit substrate FPC. The substrate FPC with the plural while light emitting diodes WLD is provided on one side of the side wall surface of the light guide panel CLB so that the light emitting diodes WLD face the specific side of the side wall surface of the light guide panel CLB. In the backlight BL, the light source functions as a surface light source. In other words, the light from each white light emitting diode WLD is incident to the side wall surface of the light guide panel CLB. The incident light is reflected or refracted in the light guide panel CLB, and is output from the surface facing the liquid crystal display panel PNL.

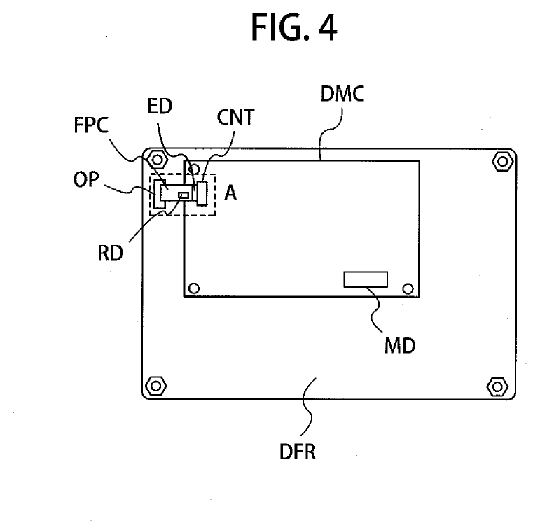

FIG. 3 is a perspective view only showing the light source LS formed by the flexible circuit substrate FPC and the white light emitting diodes WLD. An end portion ED on the power supply side of the flexible circuit substrate FPC is electrically coupled to an image processing circuit (T-con)(denoted by reference symbol DMC in FIG. 4), which will be described below, through a connector (denoted by reference symbol CNT in FIG. 4). In this way, the power is supplied from the side of the image processing circuit DMC to light each white light emitting diode WLD.

Returning to FIG. 2, the backlight BL is housed in a lower frame DFR as an enclosure, constituting a module with an upper frame and a middle frame, not shown, in addition to the liquid crystal display panel PNL and the optical sheet OS.

FIG. 4 is a top view of the modular liquid crystal display device, as seen from the back surface of the liquid crystal display device, namely, the side of the lower frame DFR.

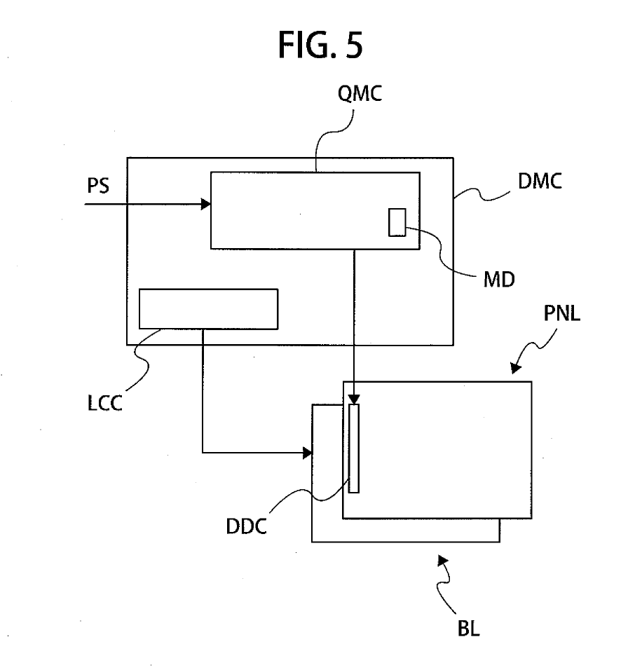

The image processing circuit DMC with a print substrate is mounted on the lower frame DFR. Although not shown, the image processing circuit DMC includes at least an image processing circuit (denoted by reference symbol QMC in FIG. 5) and a light source control circuit (denoted by reference symbol LCC in FIG. 5).

Here, an opening OP is formed in a portion adjacent to the image processing circuit DMC of the lower frame DFR. The end portion ED on the power supply side of the flexible circuit substrate FPC of the light source LS is extracted from the opening OP. The end portion ED of the flexible circuit substrate FPC is inserted into the connector CNT mounted on the image processing circuit DMC. In this way, the flexible circuit substrate FPC is electrically coupled to the image processing circuit DMC.

Here, the surface adjacent to the end portion ED of the flexible circuit substrate FPC, which is the portion extracted from the opening OP of the lower frame DFR, is allocated to information RD about the white tolerance of the light source LS, which indicates one rank of plural ranks assigned to the white tolerance.

The information RD is as follows. That is, as described above, the backlight BL has the light source using plural white light emitting diodes WLD in which color variation should occur. As a result, the occurrence of the white tolerance is inevitable in each mass-produced backlight BL. Before a liquid crystal display panel is assembled into a module with a mass-produced backlight BL, the rank of the white tolerance of the backlights BL is defined. The rank is divided into, for example, six ranks A to F, which are defined in such a way that the design center value of rank A is within plus or minus 1.01, the design center value of rank B is within plus or minus 0.01 to 0.02, the design value of rank C is within plus or minus 0.02 to 0.03, and so on. In other words, one of these ranks is specified to the backlight BL shown in FIG. 2. The information RD about the rank of the backlight BL is clearly indicated, for example, in the above specific portion of the flexible circuit substrate FPC. Here, the information RD is clearly indicated in the specific portion of the flexible circuit substrate FPC, taking into account the availability of achieving efficiency in the assembly of the modular liquid crystal display device, as well as the subsequent correction of the gamma characteristics of the image signal based on the lookup table for image control.

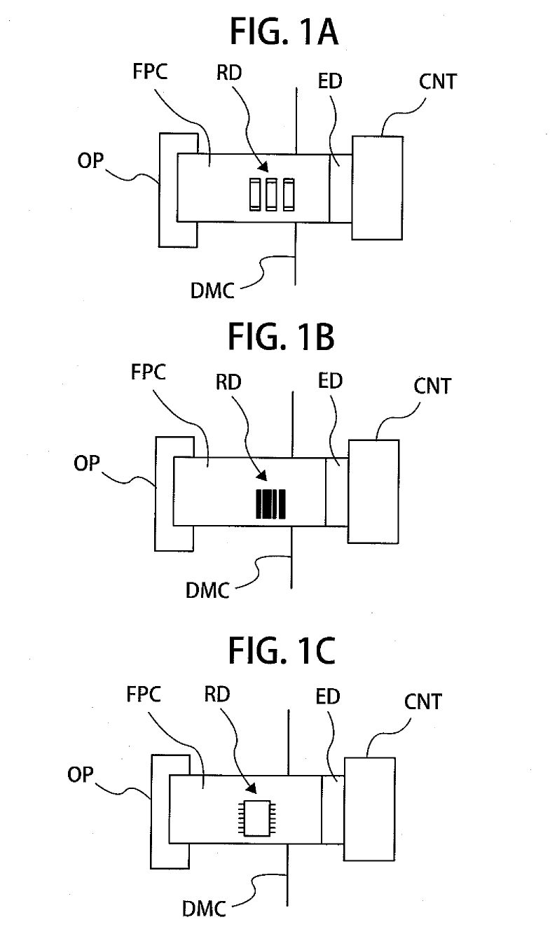

FIG. 1A is an enlarged view of a portion A surrounded by the dotted line in FIG. 4, showing a specific example of the information RD clearly indicated in the flexible circuit substrate FPC. In FIG. 1A, the information RD is formed by a dummy resistance attached to the flexible circuit substrate FPC. The dummy resistance includes, for example, three resistances arranged in parallel, each of which represents data of “0” or “1”. By means of the dummy resistance it is possible to recognize the information about one rank of at most eight ranks.

FIG. 1B is a view corresponding to FIG. 1A, showing another specific example of the information RD. In FIG. 1B, the information RD is formed by a bar cord printed on the flexible circuit substrate FPC. The information written in the bar cord can be read by a detector not shown. In this case, the greater the number of lines of the bar cord is, the more the information content will be. By means of the bar code it is possible to recognize the information about one rank of the plural ranks, similarly to the dummy resistance shown in FIG. 1A.

FIG. 1C is a view corresponding to FIG. 1A, showing still another specific example of the information RD. In FIG. 1C, the information RD is stored in a memory device of a semiconductor device that is mounted on the flexible circuit substrate FPC. The information RD stored in the memory device can be read by a device not shown. By means of the memory device, it is possible to recognize the information about one rank of the plural ranks, similarly to the dummy resistance shown in FIG. 1A.

The information RD, which is clearly indicated in the flexible circuit substrate FPC, can be read, for example, after the liquid crystal display device is assembled into a module. Then, a signal corresponding to the information is transmitted to the image processing circuit DMC mounted on the image quality processing circuit (denoted by reference symbol QMC in FIG. 5). The gamma characteristics of the image signal can be corrected by the image quality processing circuit QMC of the image processing circuit DMC. Thus, FIG. 5 is a schematic block diagram of the image processing circuit DMC. In FIG. 5, there is also shown the liquid crystal display panel PNL to which a signal is transmitted from the image processing circuit DMC, as well as the backlight BL. An image signal SP, which is an external signal, is input to the image quality processing circuit QMC of the image processing circuit DMC. The image quality processing circuit QMC can correct the gamma characteristics of the image signal based on the information stored in the memory device MD provided in the image quality processing circuit QMC. More specifically, the image quality processing circuit QMC includes, for example, a lookup table (not shown) for image control, in order to correct the gamma characteristics of the image signal according to the information stored in the memory device MD. Note that the information stored in the memory device MD is the same information as the information RD clearly indicated in the flexible circuit substrate FPC as shown in FIGS. 1A, 1B, 1C, or is the information about the information RD. That is, the information stored in the memory device MD is the same information as the information RD or relates to the information RD, which is input to the memory device MD by a device not shown.

The image signal with corrected gamma characteristics is output from the image processing circuit DMC, and is input to the display driving circuit DDC mounted on the liquid crystal display panel PNL. The display driving circuit DDC drives each pixel of the image display unit AR by the image signal based on the corrected gamma characteristics. Further, the light source control circuit LCC is provided in the image processing circuit DMC. The white light emitting diodes WLD of the light source LS of the backlight BL are lit by the light source control circuit LCC.

As described above, an image is displayed on the liquid crystal display device. At this time, even if there is a white tolerance of the backlight BL, it is possible to correct the gamma characteristics of the image signal input to the liquid crystal display panel PNL according to the white tolerance of the backlight BL. As a result, an image with suppressed color variation is displayed. In this case, the information RD about the white tolerance of the backlight BL is the information indicating one rank of plural ranks assigned to the white tolerance. As the gamma characteristics are corrected by the input of the information, it is possible to eliminate the disadvantage of the backlight BL in terms of the white tolerance, by a very simple operation. In addition, the information RD is clearly indicated in the specific portion of the flexible circuit substrate FPC of the light source LS, which is electrically coupled to the image quality processing circuit QMC. Thus, the information RD is easily recognized when the information RD is input to the image quality processing circuit QMC, allowing easy correction of the gamma characteristics of the image signal by the image quality processing circuit QMC.

### Second Embodiment

Of the embodiments described above, FIG. 1C shows an embodiment in which the information RD indicating the rank of the white tolerance of the light source LS of the backlight BL is stored in the memory device of the semiconductor device. In this embodiment, the information RD stored in the memory device is read by a person, and the person corrects the gamma characteristics of the image signal input to the liquid crystal display panel PNL according to the information RD.

However, it is also possible that the memory device is electrically coupled to the image quality processing circuit QMC for correcting the gamma characteristics of the image signal, in order to automatically correct the gamma characteristics of the image signal based on the information RD stored in the memory device. In this case, the information RD stored in the memory device is not designed to be read by a person. Thus, as shown in FIG. 1C, the information RD is not necessarily provided on the flexible circuit substrate FPC, and can be provided anywhere on the backlight BL.

### Third Embodiment

In the embodiment described above, as shown in FIG. 4, the information RD indicating the rank of the white tolerance of the light source LS of the backlight BL is clearly indicated in the visible surface of the flexible circuit substrate FPC in the state in which the flexible circuit substrate FPC is coupled to the connector CNT. However, it is also possible that the information RD is clearly indicated on a surface on the opposite side, for example, corresponding to the back of the specific surface of the flexible circuit substrate FPC. In this case, the information can be confirmed before the flexible circuit substrate FPC is coupled to the connector CNT.

### Fourth Embodiment

In the embodiment described above, the information RD indicating the rank of the white tolerance of the light source LS of the backlight BL is clearly indicated in the flexible circuit substrate FPC of the light source LS. However, the present invention is not limited to this. The information RD can be clearly indicated also in a portion of the backlight BL. In this case, it is preferable that the information RD is clearly indicated in an easily visible portion.

### Fifth Embodiment

In the embodiment described above, the backlight BL with the light guide panel CLB is used. It is also possible, however, to use the so-called direct-type backlight, in which plural light emitting diodes are dispersed on a surface of the substrate facing the liquid crystal display panel PNL. Also in the direct-type backlight, the white tolerance occurs due to the color variation of each light emitting diode, and the same problem arises as in the backlight BL with the light guide panel CLB.

Although the present invention has been described with reference to the preferred embodiments, the configurations of the previously described embodiments are merely examples, and it is to be understood that the present invention may be modified accordingly without departing from the technical spirit and scope of the present invention. Further, the configurations of the respective embodiments may be combined as long as they are consistent with each other.

What is claimed is:

1. A liquid crystal display device comprising a liquid crystal display panel to which an image signal is input, and a backlight provided on one side of the liquid crystal display panel, using a light emitting diode as a light source of the backlight,
wherein information about white tolerance of the light source using the light emitting diode, indicating one rank of a plurality of ranks assigned to the white tolerance, is clearly indicated in a portion of the backlight, and
the liquid crystal display device further comprises an image quality processing circuit to which the information can be input in order to correct gamma characteristics of the image signal according to the information.

2. The liquid crystal display device according to claim 1,
wherein the backlight includes at least a light guide panel provided to face the liquid crystal display panel, and a plurality of light emitting diodes arranged in parallel on a flexible circuit substrate so that the plurality of light emitting diodes face at least one side of a side wall surface of the light guide panel, and
the information indicating the rank of the white tolerance of the light source using the light emitting diodes, is clearly indicated in the flexible circuit substrate.

3. The liquid crystal display device according to claim 2,
wherein the light guide panel, the light emitting diodes, and the flexible circuit substrate are housed in a frame,
the frame includes a control circuit substrate for driving the light emitting diodes through the flexible circuit substrate, which is provided on a surface of the frame opposite to a surface on which the light guide panel, the light emitting diodes, and the flexible circuit substrate are mounted,
an end of the flexible circuit substrate is electrically coupled to the control circuit substrate through a connector, and
the information indicating the rank of the white tolerance of the light source using the light emitting diodes, is clearly indicated in a portion adjacent to the connector of the flexible circuit substrate.

4. The liquid crystal display device according to claim 3,
wherein the information indicating the rank of the white tolerance of the light source using the light emitting diodes, is clearly indicated by means of a dummy resistance attached to the flexible circuit substrate.

5. The liquid crystal display device according to claim 3,
wherein the information indicating the rank of the white tolerance of the light source using the light emitting diodes, is clearly indicated by means of a bar code printed on the flexible circuit substrate.

6. The liquid crystal display device according to claim 3,
wherein the information indicating the rank of the white tolerance of the light source using the light emitting diodes, is displayed at least on one of a front surface and a back surface of the flexible circuit substrate.

7. A liquid crystal display panel comprising a liquid crystal display panel to which an image signal is input, and a backlight provided on one side of the liquid crystal display panel, using a light emitting diode as a light source of the backlight,
wherein information about white tolerance of the light source using the light emitting diode, indicating one rank of a plurality of ranks assigned to the white tolerance, is stored in a memory device in a portion of the backlight, and
the liquid crystal display device further comprises an image quality processing circuit to which the information stored in the memory device can be input in order to correct gamma characteristics of the image signal according to the information.

8. The liquid crystal display device according to claim 7,
wherein the backlight includes at least a light guide panel provided to face the liquid crystal display panel, a plurality of light emitting diodes provided to face a side wall surface of the light guide panel, and a flexible circuit substrate on which the plurality of light emitting diodes are mounted, and
the memory device is mounted on the flexible circuit substrate.

9. The liquid crystal display device according to claim 7,
wherein the memory device is electrically coupled to the image quality processing circuit, so that the information stored in the memory device can be output to the image quality processing circuit.

10. The liquid crystal display device according to claim 1,
wherein the backlight includes a plurality of light emitting diodes dispersed on a surface facing the liquid crystal display panel.

11. The liquid crystal display device according to claim 7,
wherein the backlight includes a plurality of light emitting diodes dispersed on a surface facing the liquid crystal display panel.
